(19) United States
(12) Patent Application Publication
(10) Pub. No.: US 2010/0321384 A1
(43) Pub. Date: Dec. 23, 2010

(54) Method, Arrangement and Computer Program for Visualising a Biochemical Pathway

(76) Inventor: Jacqueline Francisca Gerarda Maria Schooleman, Eindhoven (NL)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/855,375

(22) Filed: Aug. 12, 2010

Related U.S. Application Data
(63) Continuation of application No. 11/509,524, filed on Aug. 24, 2006, now abandoned.

(30) Foreign Application Priority Data
Aug. 26, 2005 (NL) NL 1029820

(51) Int. Cl. G06T 15/00

(52) U.S. Cl. 345/419

(57) ABSTRACT

The present invention relates to a method of visualising a biochemical pathway, wherein said pathway represents a plurality of reaction stages linked by reaction steps. Said reaction stages are represented by nodes of said pathway. Said reaction steps are represented by links in between said nodes of said pathway. Node attributes of said nodes are retrieved from a database. Said method comprises the steps of: receiving at least one node attribute type indicating node attributes of a same nature; forming a plurality of collections of one or more nodes of said nodes, said one or more nodes of each collection having same node attributes of said received attribute type; and visualising said pathway on display means in at least three dimensions, wherein collections are distinguishably visualised from each other in at least one grouping dimension of said at least three dimensions.

### FIELD OF THE INVENTION

The present invention relates generally to a method, arrangement and computer program for visualising a biochemical pathway, and more specifically, according to a first aspect, to a method of visualising a biochemical pathway, wherein said pathway represents a plurality of reaction stages linked by reaction steps, wherein said reaction stages are represented by nodes of said pathway, wherein said reaction steps are represented by links in between said nodes of said pathway, and wherein node attributes of said nodes are retrieved from a database.

According to a second aspect, the present invention relates to an arrangement for carrying out a method as described above, and according to a third aspect the present invention relates to a computer program for visualising a biochemical pathway for carrying out said method as described above.

### BACKGROUND OF THE INVENTION

Biochemical pathways are ways to describe physiological processes taking place in a human or animal body, widely used in the field of medical technology, biology and biochemistry. Such physiological processes include chains of reactions for instance in a human or animal body, between proteins, antibodies, and other body-own substances and substances present in a body such as drugs, viruses, bacteria, metabolites, etc.

Such physiological processes are often comprised of a large number of biochemical reactions and other processes taking place in different locations in the body, and mutually influencing each other. For instance a drug for stimulating the production of a specific hormone, may cause higher hormone concentrations and the desired effect (e.g. increase fertility), while on the other hand the increased hormone concentrations result in negative side effects by triggering other processes in the bloodstream (e.g. suppressing the operation of the thyroid gland, potentially leading to the damaging thereof). These negative side-effects may on their turn trigger additional processes in other parts of the body, leading to a chain reaction the consequences of which cannot always be overseen (e.g. damaging of the thyroid gland may lead to hyper- or hypothyroidism, having again negative side-effects on the general functioning of the body, and the well-being of a person).

In general, biochemical pathways are comprised of a plurality of nodes interlinked by links. These nodes represent different stages of a (chain) reaction taking place in a body (e.g. the acting of a protein on a biochemical substance). Each reaction step (e.g. the breaking up of the biochemical substance into reaction products by the protein) is indicated by a link leading to another reaction stage (e.g. the availability of fragments of the molecule formerly forming the biochemical substance). The node showing the reaction product is than again interlinked with one or more further nodes that are influenced by the production of these reaction products.

In practice, visualisation of a biochemical pathway as described above, even when done schematically by a researcher for evaluation, often results in a complex diagram. It therefore does not provide the desired level of overview over the whole process. This enlarges the chance of overlooking specific implications and missing the connection between an event in a first part of the body and the occurence of an effect in another part of the body.

### SUMMARY OF THE INVENTION

It is therefore an object of the present invention to provide a method and arrangement for visualising a biochemical pathway, providing a clear overview of the pathway to the benefit of the user thereof.

According to a first aspect of the present invention, this object is achieved in that there is provided a method of visualising a biochemical pathway, wherein said pathway represents a plurality of reaction stages linked by reaction steps, wherein said reaction stages are represented by nodes of said pathway, wherein said reaction steps are represented by links in between said nodes of said pathway, and wherein node attributes of said nodes are retrieved from a database, said method comprising the steps of: receiving at least one node attribute type indicating node attributes of a same nature; forming a plurality of collections of one or more nodes of said nodes, said one or more nodes of each collection having same node attributes of said received attribute type; visualising said pathway on display means in at least three dimensions, wherein collections are distinguishably visualised from each other in at least one grouping dimension of said at least three dimensions.

In connection to the above, it is noted that each reaction stage and reaction step may be described in terms of attribute of that stage or step, which attributes on their turn may be described by attribute types. To give an example a reaction stage comprising a biochemical substance bound to a protein may be described in terms of the type of actor present in the reaction stage and the type of substrate present in this stage. The type of actor and the type of substrate are attribute types and the corresponding attributes to the type of actor for this reaction stage is protein, while the corresponding attribute to the type of substrate in this present example is the biochemical substance which is bound by the protein. In this example, on even a lower level, the attribute which corresponds to the attribute type ‘type of actor’ may even be a specific protein, such as thyroxine binding globulin (TBG), while the type of biochemical substance may for instance be thyroxine (T4).

According to the present invention, by forming collections of one or more nodes for which the attributes of the received attribute type are the same, and by using at least one of three or more available dimensions for visualising the pathway for distinguishably visualising the collections formed (said at least one dimension being the grouping dimension), it becomes possible for the user of the method to visualise the pathway such that it provides sufficient overview over the aspects of the pathway which are of interest. To give an example, a researcher investigating the functioning of the thyroid gland, may summarize a biochemical pathway on type of substrate, in order to distinguishably visualise the presence of T4 as a substrate in different nodes of the pathway. This will provide him with a clue to the processes influenced by the production of the T4 hormone in the thyroid gland.

As another example, medical personnel may summarize a biochemical pathway to the node attribute type ‘location in the body’, in order to distinguishably visualise processes taking place in different organs. This may help in understanding how a certain deficiency in one part of the body may result in negative effects, such as pain, in another part of the body.

The attribute type used for forming collections of nodes, may be provided by a user as input. Said user may use standard input means such as a keyboard, a data recording device (disk drive or CD-ROM), or remote input via a network connection, or the like.

Distinguishably visualising the collection in the at least one grouping dimension of the at least three dimensions may be performed in different ways. According to an embodiment, each collection is assigned a collection level in the grouping dimension, and the collection is visualised at said level relative to said grouping dimension. The node forming the collection may for instance be visualised on a coordinate plane for which the collection coordinate value of the grouping dimension is fixed for said plane. Suppose that for instance a collection of nodes is assigned collection coordinate value z=10 in a coordinate system xyz. A plane perpendicular to the grouping dimension (indicated by the z-axis) at z=10 is then used for visualising all of the nodes of said collection.

According to another embodiment said coordinate is not fixed, but is comprised in predetermined range (e.g. z=10+/−5). The collections may be visualised in clouds within each collection space.

In another embodiment of the present invention, a plurality of sub-collections is formed for at least one of the collections formed. Said sub-collections are formed by summarizing the at least one collection based on a further node attribute type, such that the nodes in each sub-collection have a same further node attribute. For example the nodes summarized to provide an overview of nodes wherein the hormone is present as a substrate may be summarized even further by dividing the nodes of the collection in sub-collections based on the location in the body corresponding to the specific reaction stage (e.g. thyroxine (T4) bound by thyroxine binding globulin (TBG) is mainly found in the bloodstream).

The benefit of this embodiment is that it can help to specifically understand and pinpoint effects of a physiological chain reaction, since it provides a suitable overview for making such an assessment.

The above-mentioned sub-collections may again be visualised distinguishably e.g. at a sub-collection level of the grouping dimension. Another method of visualising the sub-collections distinguishably is by using a further grouping dimension for distinguishably visualising sub-collections within a collection.

According to another embodiment of the present invention, the node attributes can be further visualised by varying at least one node format element, said format element selected from a group comprising colour, intensity, size, shape, transparency of said nodes. Correspondingly and according to another embodiment of the present invention, link attributes of said links may be visualised by varying at least one link format element, said format element selected from a group comprising colour, intensity, size, shape, arrows, and transparency of said links.

It will be understood that the use of distinguishing formats for the nodes an/or the links will provide benefits with respect to the level of overview provided by the schematically illustrated pathway, using a method according to the present invention.

One of the aspects of biochemical pathways that adds a great deal of complexity to the pathways, is the dynamics of a physiological process. Most reactions and events taking place within the physiologicalal process happen at a certain point in time, either subsequently to each other, or simultaneous or partly simultaneous. Some of these processes may only interfere or interact with other processes if these processes happen at the same time, or within a certain order.

From a statically visualised pathway, no insight can be gained in the dynamics of a physiological process, as will be understood. Providing and visualising dynamics of the biochemical pathway may therefore be desired. According to another embodiment of the present invention, node attributes of nodes are therefore modified in time such as to represent said reaction dynamics, and accordingly, a node format of said visualised nodes is modified in time such as to represent said modifications of said node attributes.

Correspondingly, and according to another embodiment, link attributes of said links are modified in time such as to represent said reaction dynamics, and said link format is modified in time corresponding to said modifications offset link attributes.

It will be understood that reaction dynamics may beneficially be visualised using the above-described embodiments of the invention. Dynamically modifying the formats of nodes and links may, for example, include increasing or decreasing the thickness of a link in dependence of the speed in which a reaction takes place, increasing transparency of a node over time such as to represent the level of existence of a reaction stage over time (such as the concentration of a protein bound substance in the bloodstream), varying the size of arrow heads of a double arrow of a link indicating the bi-directional reaction speed of an equilibrium reaction, etc.

According to an embodiment of the present invention, the node attribute type is selected from a group comprising type of actor, type of substrate, type of product, status of an actor, status of a substrate, location in a human or animal body. It will be understood that the attributes corresponding to the above-mentioned attribute types may be in any level of detail.

Where the attribute type is type of actor in a reaction stage, the corresponding attributes may be selected from a group comprising proteins, enzymes, or antibodies.

Where according to another embodiment, the attribute type is type of substrate, the corresponding attributes may be selected from a group comprising metabolites, drugs, bacteria, viruses, DNA or RNA fragments, hormones or other biochemical substances.

According to another embodiment, where attribute type is type of product at a reaction stage, the corresponding attribute may be selected from a group comprising metabolites, DNA or RNA fragments, or other biochemical substances.

According to another embodiment, where the node attribute type is status of the actor, the corresponding attributes may include any of a group comprising active, passive, alive, dead, conformation status of the actor, bound to substrate, or interaction potential of the actor.

According to another embodiment of the invention, where the node attribute type is said status of said substrate at a reaction stage, said attribute corresponding to said attribute type are selected from a group comprising active, passive, alive, dead, or bound to actor.

According to another embodiment of the present invention, where said node attribute type is location in said human or animal body, said attributes corresponding to said attribute type are selected from a group comprising organs, body parts, bloodstream, cell, cell nucleus, cell membrane, or other constituents of a cell, such as mitochondrion, Endoplasmic Reticulum (ER), cytosol, vacuole, etc. Note that organs may include brains, heart, kidneys, liver, skin, thyroid gland, lungs, stomach, etc. On a lower level, location in said human or animal body may also include location within a cell in said human or animal body such as cell nucleus, cell membrane, etc.

According to yet another embodiment of the present invention, the link attributes are selected from a group comprising direction of the reaction step, intensity of the reaction step, speed of the reaction step, temperature dependency of the reaction step, progress of the reaction step type of reaction step such as biochemical reaction or electrochemical reaction.

Complex biochemical pathways to which the method of the present invention may beneficially applied, includes metabolic pathways, signal transduction pathways and molecular biological pathways.

According to a second aspect of the present invention, there is provided an arrangement for visualising a biochemical pathway, for carrying out a method as described above, said pathway comprising a plurality of nodes representing reaction stages and links in between said nodes representing reaction steps between said reaction stages, said arrangement comprising a database for providing node attributes of said nodes, input means for receiving at least one node attribute type indicating node attributes of a same nature, control means arranged for forming a plurality of collections of one or more nodes of said nodes, said one or more nodes of each collection having same node attributes of said received attribute type, and means for visualising said pathway on display means in at least three dimensions, said means for visualising said pathway being further arranged for visualising said collections distinguishably from each other in at least one grouping dimension of said at least three dimensions.

In particular, said arrangement may comprise input means selected from a group comprising a keyboard, a data recording means, a telecommunication network connection.

The display means for use with the arrangement as described above, may according to another embodiment be selected from a group comprising a screen, a paper (where the means for visualising include a printer for printing on said paper, virtual reality display means (such as virtual reality glasses), or the like.

According to a third aspect of the present invention there is provided a computer program for visualising a biochemical pathway for carrying out a method as described above, wherein said pathway represents a plurality of reaction stages linked by reaction steps, wherein said reaction stages are represented by nodes of said pathway, wherein said reaction steps are represented by links in between said nodes of said pathway, and wherein node attributes of said nodes are retrieved from a database, said method comprising the steps of: receiving at least one node attribute type indicating node attributes of a same nature; forming a plurality of collections of one or more nodes of said nodes, said one or more nodes of each collection having same node attributes of said received attribute type; visualising said pathway on display means in at least three dimensions, wherein collections are distinguishably visualised from each other in at least one grouping dimension of said at least three dimensions.

### BRIEF DESCRIPTION OF THE DRAWINGS

The method and arrangement of the present invention will now be further elucidated by description of particular embodiments thereof, with reference to the attached drawings, wherein:

FIG. 1 is a schematic overview of a method according to the present invention;

FIG. 2 schematically shows an arrangement according to the present invention;

FIG. 3 is a simplified example of a biochemical pathway visualised using a method according to the present invention.

### DETAILED DESCRIPTION OF THE DRAWINGS

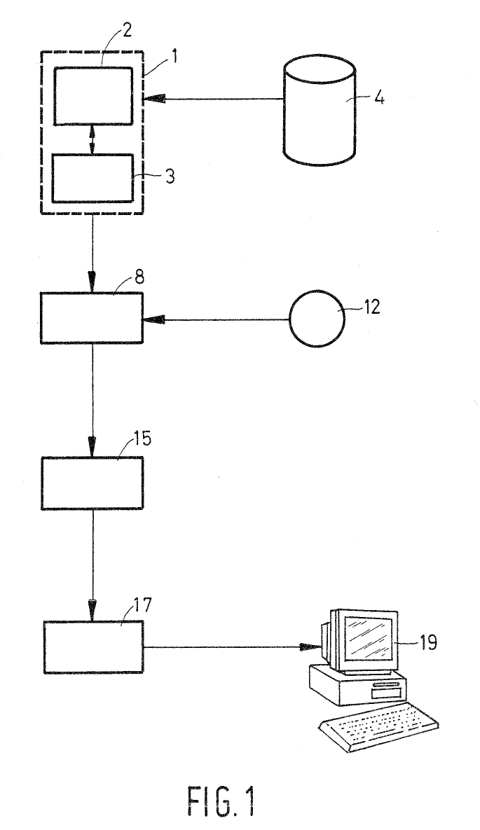

FIG. 1 schematically depict a method for visualising a biochemical pathway according to the present invention. The method comprises a step 1 of initializing the biochemical pathway, which includes a step 2 of identifying the reaction stages involved in the biochemical pathway and the step 3 of identifying the reaction steps involved in the biochemical pathway which is to be visualised. It will be understood that identifying the reaction stages 2 and identifying the reaction steps 3 involved in the biochemical pathway may be an iterative process since the steps and stages involved in the biochemical pathway depend on the presence of each other. In FIG. 1 this is indicated by a double arrow in between steps 2 and 3 of the process.

The required data for visualising the biochemical pathway, in particular the node attributes, the node attribute types and the link attributes and necessary parameter dependencies and time dependencies of the particular biochemical pathway is retrieved from a database 4. This database may be a local database stored by, for example, a computer involved in visualising the pathway, or may be a centralised database that can be consulted by a system for visualising the biochemical pathway using a telecommunication network.

When the available nodes and necessary links have been identified in step 1 of the method (initializing the pathway), in step 8, a user may input a desired attribute type, the input being schematically indicated with reference number 12, that must be used for grouping the available nodes in the pathway in desired collections. As described herein above, the user may group the available nodes based on for instance type of actor involved at the reaction stage, type of substrate, type of reaction product, location in a human or animal body, status of actor, status of substrate, etc.

In step 15, the required node attribute type for forming collections of the nodes is used for forming collections of nodes having similar attributes of the given node attribute type in step 8. Suppose for instance that the user has chosen to summarize a biochemical pathway based on a present status of an actor, the available attributes for this attribute type may be active, inactive, dead, alive, confirmation status of said actor, whether a substrate is bound to the actor, or interaction potential of an actor. Note that attributes of the nodes may include continuously variable parameter values falling within specific sub-ranges of said parameter value. For example, some reaction steps may only occur if a local temperature of the environment exceeds a certain threshold value. Therefore some reaction stages may only exist when the local temperature exceeds said threshold value. For different reaction stages this threshold value may be different. Therefore nodes may be subdivided in ranges of a threshold temperature above which said reaction stages occur.

In step 17, the biochemical pathway is visualised in three dimensions using visualisation means 19. At least one of the three dimensions, the grouping dimension, is used for distinguishably visualising the different collections of nodes formed in step 15. One may for instance think of assigning certain grouping levels corresponding a certain level in the grouping dimension, e.g. if in a Cartesian coordinate system the z-axis is used as grouping dimension, than z-coordinate z1, z2, z3, . . . may be assigned to collections C1, C2, C3, . . . of nodes of te biochemical pathway. This way all the nodes of a single collection, e.g. C1, are visualised in a plane perpendicular to the grouping dimension (z-axis), at a specific level (z1). In FIG. 1 it is suggested that visualisation takes place on the screen of computer system 19, however it will be understood that visualisation may take place in a different manner, e.g. by printing on a paper or by showing the three-dimensional structure of a biochemical pathway visualised using the present invention using virtual reality glasses (not shown).

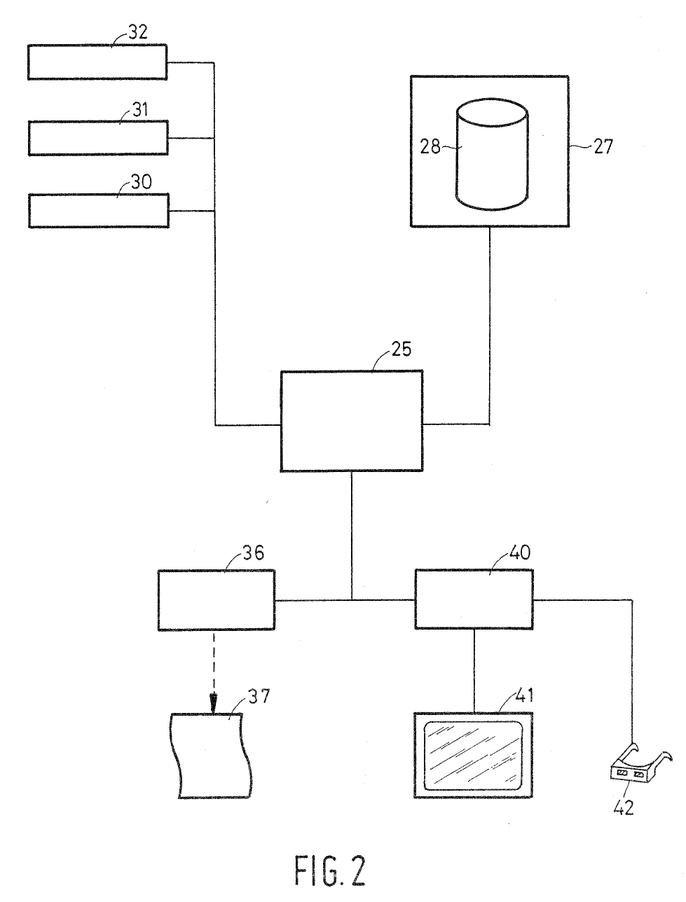

FIG. 2 shows an arrangement according to the present invention for visualising a biochemical pathway. Here control means 25 are connected to a memory 27 which stores database 28 wherein all details of an biochemical pathway are contained. As described in relation to FIG. 1, such a database may be located remotely from the other parts of the arrangement according to the present invention and may be accessible via a telecommunication network (not shown). Control means 25 are further connected to input means 30, 31 en 32. Input means 30 may e.g. represent a keyboard, input means may e.g. represent data storage means and input means 32 may resemble a network connection through which input is received.

Control means 25 are arranged for controlling the arrangement, and in particular for initializing the visualising of the pathway (step 1 in FIG. 1), and forming collections based on the received input from input means 30-32 with respect to the node attribute type, using data retrieved from database 28 in memory 27.

When the biochemical pathway is initialized and the collections of nodes are formed, control means 25 control at least one of the visualisation means 36 or 40 for visualising the biochemical pathway. Visualising means 36 resemble a printer, which prints the biochemical pathway on a piece of paper 37. Visualisation means 40 may resemble a video control card of a computer, for controlling operation of monitor 41 or virtual reality glasses 42.

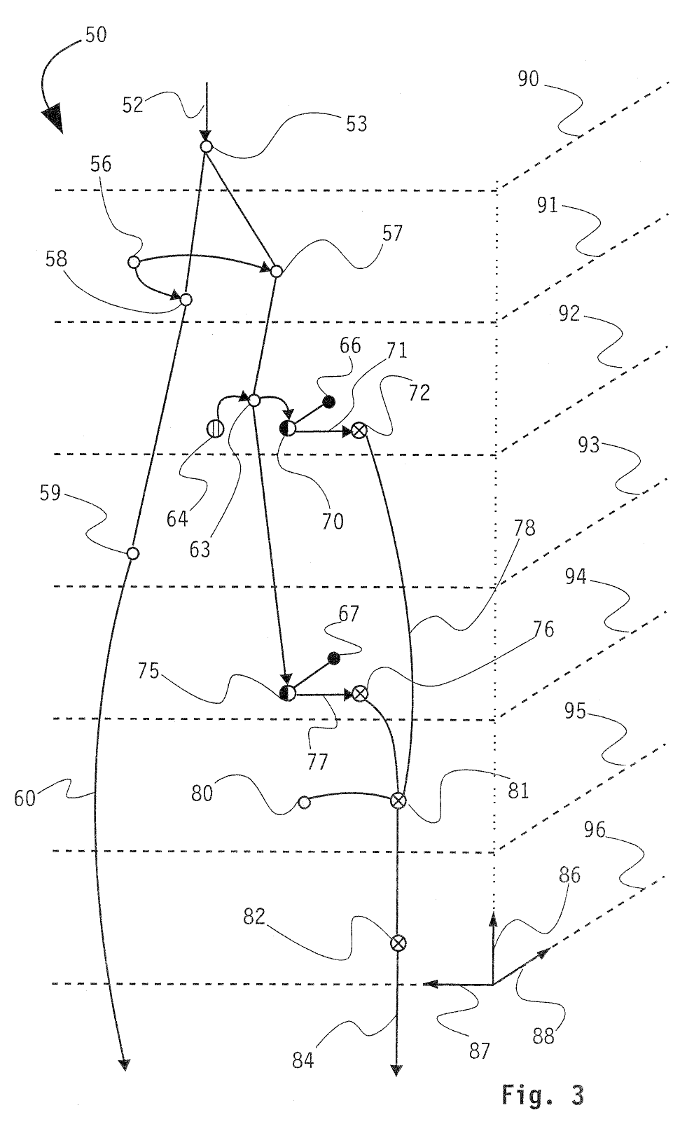

FIG. 3 provides a schematic and simplified illustration of a biochemical pathway visualised according to the present invention.

FIG. 3 schematically shows (on a high level) a biochemical pathway 50, in particular schematically indicating the functioning of an anti-malaria drug in a human body infected with malaria. In FIG. 3, the three dimensions of a Cartesian coordinate system, x, y and z are respectively indicated with reference numerals 87, 88 and 86. The dimension indicated by the z-axis 86 is used as the grouping dimension. The pathway 50 of the functioning of the anti-malaria drug is grouped in the third dimension (indicated by the z-axis) with respect to attribute type ‘location in the body’, in this particular case meaning that each node is grouped as to where the particular associated reactions stage can be found in the body of the infected person.

The biochemical pathway 50 is visualised by means of a plurality of nodes such as nodes 53, 56, 57, 58, etc. These nodes are connected by links such as link 52, 71, 72, 78 or 84 indicating reaction steps of the biochemical pathway. Each group corresponds to a particular attributes of attribute type ‘location in the body’ and is indicated by planes 90, 91, 92, 93, 94, 95, 96 perpendicular to the z-axis 86.

Plane 90 corresponds to the mouth of the human being. Plane 91 corresponds to the stomach of the human being. Plane 92 corresponds to the blood circulation of the human body. Plane 93 corresponds to the intestines of the human body. Plane 94 corresponds to the liver of the human body. Plane 95 corresponds to the kidneys of the human body, and plane 96 corresponds to the bladder of the human body.

In reaction step 52 the anti-malaria drug 53 enters the body after oral administration, associated with plane 90. In the stomach (plane 91) of the human being, the anti-malaria drug 53 reacts with constituents of stomach acid 56 such as to form reaction products 57 and 58. The active substances of anti-malaria drug 53 are indicated by node 57. Node 58 indicates inactive remains of inactive parts of anti-malaria drug 53. The inactive part 58 may leave the human body through the intestines associated with plane 93 (as indicated by node 59) and link 60 or through renal clearance associated with plane 95 (not indicated). The active part 57 of the anti-malaria drug is taken up in blood circulation (indicated by plane 92), where it e.g. can be bound by a protein 64 such as to form protein bound anti-malaria drug 63 present in the blood. Also present in the blood are plasmodium parasites 66, responsible for causing malaria. The plasmodium parasites 66 are acted upon by the anti-malaria drug 63, and plasmodium parasites under attack of the anti-malaria drug 63 are indicated by node 70. Eventually the plasmodium parasites may be killed, and dead inactive plasmodium parasites are indicated in node 72 in blood circulation plane 92. Through blood circulation 92, the protein bound anti-malaria drug 63 may also enter the liver indicated by plane 94. The plasmodium parasites are also present in the liver (indicated by node 67). Therefore again on the liver plane 94, node 75 indicates plasmodium parasites under attack by the anti-malaria drug. In node 76, the attacked plasmodium parasites may be killed and therefore inactivated.

It is noted that the rate of success of the anti-malaria drug may not be 100 percent, i.e. not all parasites attacked by the anti-malaria drug may be sensible to drug, and therefore not all parasites attacked by the anti-malaria drug are affected by it. This may be indicated by amending the shape or format of link 71 and/or link 77 between respectively nodes 70 and 72 and 75 an 76. As an example, the rate of success of the anti-malaria drug may be indicated by amending the thickness of link 71 or 77. Another option is the possibility of annotating a percentage near link 71, or presenting a bar which is partly coloured with a first colour and partly coloured with a second colour, to indicate the rate of success. As will be understood other means of presenting the rate of success of the anti-malaria drug in killing plasmodium parasites may be used within the scope of the present invention.

The killed, inactive parasites indicated by nodes 72 and 76 may after decomposition thereof be removed from the blood through renal clearance (indicated by kidney plane 95) or other clearance mechanisms. Through bladder 96 (indicated by node 82), the soluble decomposition products of the killed inactive parasites dissolved in water (indicated by nodes 80 (water) and 81 (dissolved decomposition products)) leave the body as indicated by link 84.

It is noted that all nodes 53, 56, 57, 58, 59, 63, 64, 66, 67, 70, 72, 75, 76, 80, 81 and 82 have specific attributes, that may be grouped by attribute type as indicated by visual characteristics in FIG. 3. As an example, as depicted in FIG. 5, the filling of each node may give an indication of the substrate involved at the reaction stage. The unfilled nodes 53, 57 and 63 indicate the presence of the active part of the malaria drug. Gray-shaded nodes 56, 58, 59 and 80 indicate the presence of a general biochemical substance as a substrate. In particular, the biochemical substance in node 56 is stomach acid. While in node 58 and 59 it is formed by waste products of the anti-malaria medicine after it has been acted upon by the stomach acid 56. In node 80, the biochemical substance is regular water, used in kidneys for binding or dissolving waste products. The black nodes 66 and 67 indicate parasites.

Other characteristics of the format may indicate e.g. a status of the reaction stage. The half-black-half-white nodes 70 and 75 indicate plasmodium parasites which are under attack by the anti-malaria drug. Nodes which are crossed through, such as nodes 72, 76, 81 and 82 indicate (the presence of) inactive or dead plasmodium parasites in said associated reaction stage.

To a researcher, the three-dimensional grouping used for presenting pathway 50 directly reveals, which steps are taking place where in the body. It will be understood that pathway 50 is illustrated n FIG. 3 schematically and in a highly simplified form. In reality, the functioning of an anti-malaria drug may be different from what is being presented in FIG. 3, however FIG. 3 merely provides an example of how pathway 50 may be visualised using the method of the present invention. In reality, pathways are often much more complicated, and each of the nodes indicated in FIG. 3 may be linked with additional nodes (which are not shown in FIG. 3) indicating an interaction of any kind between substances present in a certain reaction stage and substances in another reaction stage of a different biochemical process in the body. In particular, a pathway such as pathway 50 may be interlinked with a large number of other biochemical pathways. In particular for some anti-malaria drugs, a large number of undesired side-effects are known. As an example, it is known that the use of doxycycline as malaria profilaxis causes to a certain degree allergic reactions in response to sunlight, in some patients. These side-effects may be caused by the influence of the anti-malaria drug in the body on other processes. A number of connections with other biochemical pathways may therefore be expected for a biochemical pathway such as pathway 50 shown in FIG. 3.

It will be understood that pathway 50 could have been grouped differently, e.g. by substrate type. This would lead to different insight in the functioning of the anti-malaria drug of interest. It is to be understood that grouping as to different attribute types compared to the grouping illustrated in FIG. 3 is included in the scope of the invention as defined in the claims.

In the above-mentioned description, in combination with the enclosed drawings, the invention has been described in terms of specific embodiments thereof. It is to be understood that the above-mentioned embodiments described, are only intended to increase understanding of the invention, and are by no means intended to be limiting on the invention described, the scope of which is provided by the appended claims.

1. Method of visualising a biochemical pathway, wherein said pathway represents a plurality of reaction stages linked by reaction steps, wherein said reaction stages are represented by nodes of said pathway, wherein said reaction steps are represented by links in between said nodes of said pathway, and wherein node attributes of said nodes are retrieved from a database, said method comprising the steps of:
receiving at least one node attribute type indicating node attributes of a same nature;
forming a plurality of collections of one or more nodes of said nodes, said one or more nodes of each collection having same node attributes of said received attribute type;
visualising said pathway on display means in at least three dimensions, wherein collections are distinguishably visualised from each other in at least one grouping dimension of said at least three dimensions.

2. Method according to claim 1, wherein said node attribute type is received as input from a user.

3. Method according to claim 1, wherein distinguishably visualizing said collections in said at least one grouping dimension comprises assigning to each of said collections a collection level in said grouping dimension.

4. Method according to claim 3, wherein said collection level corresponds to a coordinate plane for which a collection coordinate value of said grouping dimension is fixed for said plane.

5. Method according to claim 3, wherein said collection level corresponds to a collection space for which a collection coordinate value of said grouping dimension is comprised within a predetermined range for said collection.

6. Method according to claim 5, wherein said nodes of said collection are visualised in a cloud within said collection space.

7. Method according to claim 5, wherein for at least one collection of said plurality of collections a plurality of sub-collections is formed comprising nodes of said collection having same further node attributes corresponding to a further node attribute type.

8. Method according to claim 7, wherein said plurality of sub-collections are visualised by assigning a sub-collection level to each of said sub-collections, said sub-collection level being comprised by said collection space.

9. Method according to claim 1, wherein said plurality of sub-collections within said at least one collection is distinguishably visualised in at least one further grouping dimension of said at least three dimensions.

10. Method according to claim 1, wherein node attributes of said nodes are further visualised by varying at least one node format element selected from a group comprising colour, intensity, size, shape, and transparency of said nodes.

11. Method according to claim 1, wherein link attributes of said links are visualised by varying at least one link format element selected from a group comprising colour, intensity, size, shape, arrows, and transparency of said links.

12. Method according to claim 1, wherein node attributes of said nodes are modified in time such as to represent reaction dynamics, and wherein a node format of said visualised nodes is modified in time such as to represent said modifications of said node attributes.

13. Method according to claim 1, wherein link attributes of said links are modified in time such as to represent reaction dynamics, and wherein said link format is modified in time corresponding to said modifications of said link attributes.

14. Method according to claim 1, wherein said node attribute type is selected from a group comprising type of actor, type of substrate, type of product, status of an actor, status of a substrate, location in a human or animal body.

15. Method according to claim 14, wherein said node attribute type is said type of actor of said reaction stage, and wherein said attributes corresponding to said attribute type are selected from a group comprising proteins, enzymes, or antibodies.

16. Method according to claim 14, wherein said node attribute type is said type of substrate of said reaction stage, and wherein said attributes corresponding to said attribute type are selected from a group comprising metabolites, drugs, bacteria, viruses, DNA or RNA fragments, hormones or other biochemical substances.

17. Method according to claim 14, wherein said node attribute type is said type of product at said reaction stage, and wherein said attributes corresponding to said attribute type are selected from a group comprising metabolites, DNA or RNA fragments, or other biochemical substances.

18. Method according to claim 14, wherein said node attribute type is said status of said actor at said reaction stage, and wherein said attributes corresponding to said attribute type are selected from a group comprising active, passive, alive, dead, conformation status of said actor, bound to substrate, or interaction potential of actor.

19. Method according to claim 14, wherein said node attribute type is said status of said substrate at said reaction stage, and wherein said attributes corresponding to said attribute type are selected from a group comprising active, passive, alive, dead, or bound to actor.

20. Method according to claim 14, wherein said node attribute type is said location in said human or animal body, and wherein said attributes corresponding to said attribute type are selected from a group comprising organs, body parts, bloodstream, cell, cell nucleus, cell membrane, or other constituents of a cell, such as mitochondrion, Endoplasmic Reticulum (ER), cytosol, vacuole, etc.

21. Method according to claim 1, wherein link attributes are selected from a group comprising direction of said reaction step, intensity of said reaction step, speed of said reaction step, temperature dependency of said reaction step, progress of said reaction step, type of reaction step such as biochemical reaction or electrochemical reaction.

22. Method according to claim 1, wherein said biochemical pathways are selected from a group comprising metabolic pathways, signal transduction pathways, molecular biological pathways.

23. Arrangement for visualising a biochemical pathway, for carrying out a method according to any of the previous claims, said pathway comprising a plurality of nodes representing reaction stages and links in between said nodes representing reaction steps between said reaction stages, said arrangement comprising a database for providing node attributes of said nodes, input means for receiving at least one node attribute type indicating node attributes of a same nature, control means arranged for forming a plurality of collections of one or more nodes of said nodes, said one or more nodes of each collection having same node attributes of said received attribute type, and means for visualising said pathway on display means in at least three dimensions, said means for visualising said pathway being further arranged for visualising said collections distinguishably from each other in at least one grouping dimension of said at least three dimensions.

24. Arrangement according claim 23, wherein said input means are selected from a group comprising a keyboard, a data recording means, a telecommunication network connection.

25. Arrangement according to claim 23, wherein said display means are selected from a group comprising a screen, paper, virtual reality display means such as virtual reality glasses.

26. Computer program for visualising a biochemical pathway, for carrying out a method according to claim 1, wherein said pathway represents a plurality of reaction stages linked by reaction steps, wherein said reaction stages are represented by nodes of said pathway, wherein said reaction steps are represented by links in between said nodes of said pathway, and wherein node attributes of said nodes are retrieved from a database, said method comprising the steps of:
receiving at least one node attribute type indicating node attributes of a same nature;
forming a plurality of collections of one or more nodes of said nodes, said one or more nodes of each collect/an having same node attributes of said received attribute type; visualising said pathway on display means in al least three dimensions, wherein collections are distinguishably visualised from each other in at least one grouping dimension of said at least three dimensions.
